(19) United States
(12) Patent Application Publication
(10) Pub. No.: US 2014/0154525 A1
(43) Pub. Date: Jun. 5, 2014

(54) AQUEOUS SOLUTION AND METHOD FOR THE FORMATION OF A PASSIVATION LAYER

(71) Applicants: Rene Van Schaik, Eindhoven (NL); Keith Richard Zone, Vlijmen (NL)

(72) Inventors: Rene Van Schaik, Eindhoven (NL); Keith Richard Zone, Vlijmen (NL)

(73) Assignee: ENTHONE INC., West Haven, CT (US)

(21) Appl. No.: 14/001,360

(22) PCT Filed: Feb. 23, 2012
(86) PCT No.: PCT/US12/26343

§ 371 Date: Feb. 10, 2014

(30) Foreign Application Priority Data
Feb. 23, 2011 (EP) 11155672.6

(51) Int. Cl. C23C 22/53; C23C 22/34; B05D 3/10

(52) U.S. Cl. CPC C23C 22/53; B05D 3/107; C23C 22/34
USPC 428/658; 427/343; 560/147; 562/594; 106/14.14

(57) ABSTRACT

The present invention generally relates to an aqueous solution for the formation of a passivation layer on a zinc layer or zinc-alloy layer. More particularly, the invention relates to the formation of a black passivation layer on a zinc layer or zinc-alloy layer, which passivation layer is substantially free of hexavalent chromium. Furthermore, the present invention relates to method for the formation of a passivation layer on a zinc layer or zinc-alloy layer, as well as a passivation layer on a zinc layer or zinc-alloy layer itself. The solution used contains trivalent chromium ions, nitrate ions, an organic acid and a dithioglycolate.

### REFERENCE TO RELATED APPLICATIONS

This application claims priority to European Application 11155672.6 filed Feb. 23, 2011, the entire disclosure of which is incorporated herein by reference.

### FIELD OF THE INVENTION

The present invention generally relates to an aqueous solution for the formation of a passivation layer on a zinc layer or zinc-alloy layer. More particularly, the invention relates to the formation of a black passivation layer on a zinc layer or zinc-alloy layer, which passivation layer is substantially free of hexavalent chromium. Furthermore, the present invention relates to a method for the formation of a passivation layer on a zinc layer or zinc-alloy layer, as well as a passivation layer on a zinc layer or zinc-alloy layer itself.

### BACKGROUND OF THE INVENTION

It is known in the art to protect metallic surfaces against corrosion by depositing a protective layer on such metallic surfaces. This technique is known for a long time and is versatile and used in many technical areas, e.g. automotive industry, mechanical engineering, and aerospace industry. Zinc or zinc-alloy layers have frequently been used to protect metal surfaces against corrosion. For example, it is known to plate various base metals, e.g. steel, copper, aluminum or alloys of such metals, for functional or decorative purposes. The main functional purpose is to increase the corrosion resistance of the base metal or the adherence of a surface coating, while the main decorative purpose is to provide a homogeneous surface appearance.

To increase the corrosion resistance even more, it is further known in the state of the art to passivate such zinc or zinc-alloy layer. For the passivation, the zinc or zinc-alloy layer is treated with a composition inducing the deposition of various protective metals or metal-salts, e.g. Cr, V, and Mn, on the zinc or zinc-alloy layer. The use of different protective metals causes a different appearance in color of the passivation. Especially hexavalent chromium or hexavalent chromium salts are commonly used in such passivation processes, since hexavalent chromium delivers a black appearance of the passivation layer which is preferred for many applications especially for aesthetic reasons. However, hexavalent chromium has some ecological drawbacks, so that there was a need for alternative passivation processes omitting the use of hexavalent chromium. To overcome these drawbacks different approaches are known from the state of the art.

GB 2 374 088 discloses a conversion treatment of zinc or zinc-alloy surfaces by applying a phosphate conversion coating to a zinc or zinc-alloy surface which comprises contacting the surface with an acidic solution comprising phosphate ions, nitrate ions or nitrite ions and one or both of a molybdenum or vanadium compound. Here, the term conversion coating is used synonymously to the term passivation layer.

EP 1 484 432 discloses a process solution used for forming a hexavalent chromium free, black conversion film, which is applied onto the surface of zinc or zinc-alloy plating layers, and which has corrosion resistance identical or higher than that achieved by conventional hexavalent chromium-containing conversion films. Here, the term film is synonymously used to the term layer.

However, a drawback of the hexavalent chromium free passivation processes leading to a black passivation layer known from the state of the art is that the appearance of the layers is uneven and not a real dark black but grayish. Especially when the zinc or zinc-alloy layer is deposited at low temperature, e.g. about room temperature, a subsequent passivation regularly turns out to be suboptimal only. However, plating of the zinc or zinc-alloy layers at room low temperatures is preferred due to the reduced energy costs by omitting to heat up the plating electrolyte.

### SUMMARY OF THE INVENTION

It is therefore an object of the invention to provide a process solution for the formation of a passivation layer on a zinc layer or zinc-alloy layer which is capable to overcome the drawbacks know from the state of the art, especially for zinc and zinc-alloy layers deposited at low temperatures.

### DETAILED DESCRIPTION OF PREFERRED EMBODIMENTS

Surprisingly, it was found that an aqueous process solution for the formation of a passivation layer on a zinc layer or zinc-alloy layer, the solution comprising:

a source of trivalent chromium ions;

a source of nitrate ions; and

an organic acid;

characterized in that the solution comprises a dithiodiglycolate according to the general formula

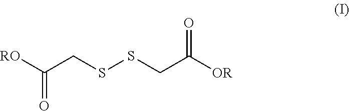

wherein R is H, Li, Na, K, NH₄, or a branched or unbranched alkyl group having 1 to 8 carbon atoms, forms a black passivation layer also on zinc or zinc-alloy layers which passivation layer has a real dark black appearance, also on zinc or zinc-alloy layers deposited at low temperatures. Additionally, it was found to form a very good primer for paints and lacquers, offering superior adhesion properties.

According to an embodiment of the invention, the dithiodiglycolate according to the general formula (I) can be comprised in the aqueous process solution in a concentration between 0.1 mmol/l and 1 mol/l. Preferably, the dithiodiglycolate is comprised in the solution in a concentration within the range of 0.2 mmol/l to 0.1 mol/l.

According to a further embodiment of the invention, trivalent chromium ions can be comprised in the aqueous process solution in a concentration between 4 mmol/l and 0.2 mol/l. Preferably, the trivalent chromium ions are comprised in the solution in a concentration within the range of 10 mmol/l to 0.15 mol/l.

The source of the trivalent chromium ions may be any chromium compound releasing trivalent chromium. Preferably, as a source for the trivalent chromium ions at least one compound of the group consisting of chromium chloride, chromium sulfate, chromium nitrate, chromium phosphate, chromium dihydrogen phosphate, and chromium acetate is used. Especially preferred, chromium sulfate is used as a source for trivalent chromium ions.

According to a further embodiment of the invention, the nitrate ions may be comprised in the aqueous process solution in a concentration between >0 mmol/l and 2 mol/l. Preferably, the nitrate ions are comprised in the solution in a concentration within the range of 10 mmol/l to 1 mol/l. The source of the nitrate ions may be any nitrate compound sufficiently releasing nitrate in an aqueous medium. Preferably, as a source for the nitrate ions at least one compound of the group consisting of sodium nitrate, chromium nitrate, nitric acid, potassium nitrate, zinc nitrate, and ammonium nitrate.

According to a further embodiment of the invention, the organic acid comprised in the aqueous process solution may be at least one acid of the group consisting of citric acid, malonic acid, formic acid, tartaric acid, lactic acid, malic acid, gluconic acid, ascorbic acid, oxalic acid, succinic acid, and adipic acid. Preferably, the organic acid may be comprised in the aqueous process solution in a concentration between >0 mmol/l and 2 mol/l. Preferably, the organic acid is comprised in the solution in a concentration within the range of 10 mmol/l to 1 mol/l.

According to another embodiment of the invention, at least some of the chromium ions in the solution are coordinated by a complexing agent. The complexing agents usable in the inventive aqueous process solution include hydroxy carboxylic acids such as tartaric acid or malic acid, monocarboxylic acids, or polycarboxylic acids such as oxalic acid, malonic acid, succinic acid, citric acid. Also complexing agents like EDTA (ethylene diamine tetraacetic acid), NTA (nitrilo triacetic acid), and EDDS (ethylene diamine disuccinic acid) can be used in the inventive process solution.

The complexing agent may be comprised in the inventive process solution in a concentration within the range of 0 mol/l to 2 mol/l. Preferably, the molar ratio of the complexing agent to the trivalent chromium is within the range of 0.05:1 to 250:1.

According to a further embodiment of the invention, the aqueous process solution may also comprise a source of a metal of the group consisting of Sc, Y, Ti, Zr, Mo, W, Mn, Fe, Co, Ni, Zn, B, Al, and Si. Such metals increase the corrosion resistance of the passivation layer. The aforementioned metals may be comprised in the solution in a concentration within the range of 0 mol/l to 2 mol/l.

According to a further embodiment of the invention the composition comprises a source of fluoride. Such a source of fluoride can be, e.g. a fluoride salt, like sodium fluoride, potassium fluoride, or a fluoride compound like sodium bifluoride, potassium bifluoride, or ammonium fluoride. The fluoride can be comprised in the composition in a concentration of between 0 mol/l to 0.5 mol/l, preferably between 0 mol/l and 0.05 mol/l. The addition of a source of fluoride to the composition enhances the optical appearance of the passivation layer and makes it look more evenly and glossy.

Besides, the invention further relates to a method for the formation of a passivation layer on a zinc layer or zinc-alloy layer, the method comprising the steps:

depositing a zinc or zinc-alloy layer on a substrate surface;

treating the deposited zinc or zinc-alloy layer with a aqueous process solution comprising a source of trivalent chromium ions, a source of nitrate ions, an organic acid, and a dithiodiglycolate according to the general formula

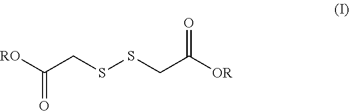

wherein R is H, Li, Na, K, NH₄, or a branched or unbranched alkyl group having 1 to 8 carbon atoms.

According to the inventive method, it is preferred that the zinc or zinc-alloy layer is deposited from an acidic electrolyte.

The following composition should be understood as a non limiting example of an acidic zinc electrolyte usable to deposit a zinc layer on which layer a passivation layer can be formed by making use of the inventive method and/or the inventive composition.

### Example 1

An aqueous composition comprising at least
Zinc Chloride 62 g/l;
Boric acid 25-30 g/l; and
Potassium Chloride 210 g/l.

The pH value at room temperature of the composition as described above is in the range of between pH 4 and pH 6. Preferably, the composition is free of complexing agents.

### Example 2

An aqueous composition comprising at least
Zinc Chloride 62 g/l;
Ammonium Chloride 45 g/l; and
Potassium Chloride 162 g/l.

The pH value at room temperature of the composition as described above is in the range of between pH 4 and pH 6. Preferably, the composition is free of complexing agents.

Optionally, the zinc electrolyte mentioned in the examples 1 or 2 above can comprise a brightener. An example for a brightener usable in such zinc electrolytes is an additive commercially available from Enthone Inc., West Haven, Conn., under the name trademark ENTHOBRITE CLZ.

In a preferred embodiment of the inventive method, the zinc or zinc-alloy layer is deposited from an acidic electrolyte comprising a thiodiglycol ethoxylate. The thiodiglycol ethoxylate may be comprised in the plating electrolyte in a concentration within a range of 0 mol/l to 1.0 mol/l, preferably within a range of 0.01 mol/l to 0.1 mol/l. For example, thiodiglycol ethoxylate to be used according to the inventive method may have a density within the range of 1.05 g/cm³ and 1.25 g/cm³, preferably within the range of 1.11 g/cm³ and 1.13 g/cm³. The pH of the thiodiglycol ethoxylate preferably can be in the range of pH 6.0 to pH 7.5. The viscosity of the thiodiglycol ethoxylate preferably can be in the range of 100 mPa*s to 160 mPa*s at 40° C.

The thiodiglycol ethoxylate employed in the zinc or zinc alloy deposition step is thought to interact with the dithioglycolate used in the subsequent passivation step in combination with the trivalent Cr ions to yield a passivation which is surprisingly better than prior art coatings for absorbing light across the entire visible light spectrum. This yields the especially dark black, consistent, long-lasting passivation of the invention, which is not obtained with prior Cr-based passivation of zinc-based coatings.

According to a preferred embodiment of the invention, the zinc or zinc-alloy layer is deposited at low temperature, preferably at a temperature ≦30° C. This omits the need of additional heating of the plating electrolyte which gives economical benefit to the process by reducing the energy costs.

Metal alloying elements which can be deposited together with zinc in the plating step according to the inventive process may be at least one metal of the group consisting of Co, Sn, Fe, Cu, Ni, Mn, Ag. The alloy metal can be comprised in the zinc or zinc-alloy layer in a range between 0.1% by weight to 90% by weight. The alloy metal may improve the wear resistance of the zinc-alloy layer, its corrosion resistance, or the appearance of the layer or the subsequent passivation layer.

According to a further embodiment of the invention, subsequent to the formation of the passivation layer, the surface may be treated with a film-building polymeric solution to improve the corrosion resistance. Such film building polymeric solutions are well known in the art. However, surprisingly it was found that the black passivation layer formed by the inventive process even without the additional polymeric film has an improved corrosion resistance, so that the thickness of an additional polymeric film can be reduced. This makes the surface of a substrate even glossier in its appearance, so that a surface having a bright shiny black color can be achieved.

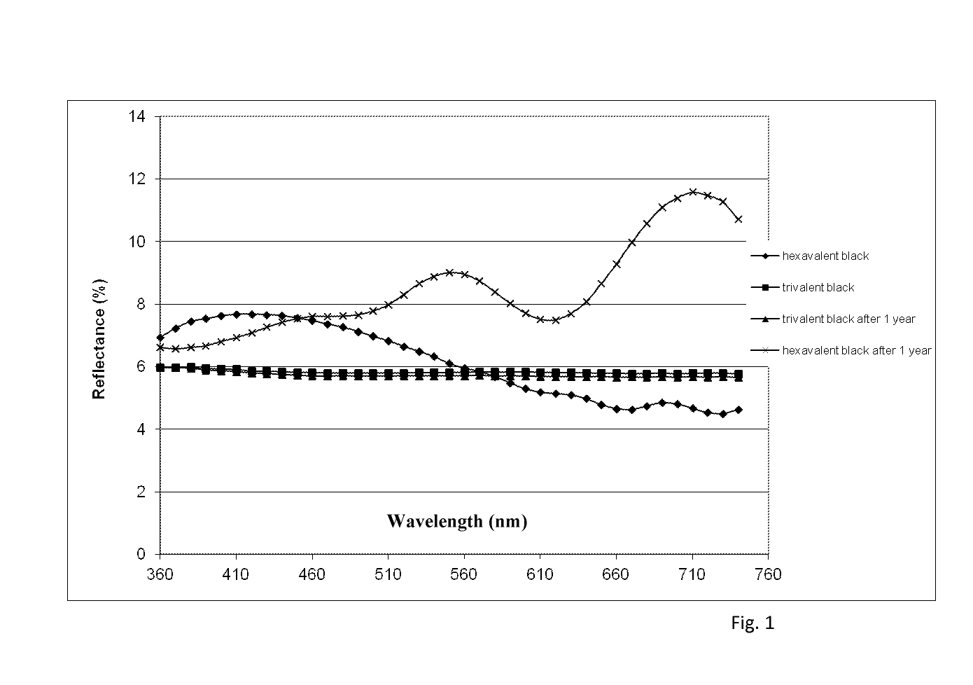

Besides, the invention further relates to a passivation layer on a zinc layer or zinc-alloy layer, said passivation layer having an average optical surface reflectance at a wavelength within the range of 360 nm to 710 nm of less than 8%, preferably less than 7%, wherein the fluctuation range of the reflectance is ≦2%, preferably ≦1%. Surprisingly it was found that with this the inventive passivation layer has a deep black appearance. This black appearance lasts also under sunlight radiation over at least one year, as demonstrated in FIG. 1.

In FIG. 1 different black passivations on a zinc plated standard steel substrate are compared with respect to their reflectance. One passivation solution is a solution according to the state of the art comprising chromium(VI) ions (referred to a “hexavalent black” passivation). The other passivation solution is one according to the invention as disclosed herein (referred to as “trivalent black” passivation). Reflectance was measured directly after passivation, and after one year of sunlight exposure. As can be seen in FIG. 1, the reflectance curve of the trivalent passivated substrate directly after passivation is almost the same as after one year of sunlight exposure, while the reflectance curve of the hexavalent passivated substrate shows a significantly change in the reflectance characteristics, especially a higher wavelength (>500 nm). So, the optical appearance has changed from black to more grayish. Furthermore, the fluctuation range of the reflectance of the freshly trivalent passivated substrate over a wavelength rang of 360 nm to 710 nm is about 1% only, while the fluctuation range of the reflectance of the freshly hexavalent passivated substrate over the same wavelength range is about 3.5%, which result in a much more even appearance of the substrate passivate according to the invention as described herein. This effect increases by exposure of the passivated substrate to sunlight. After one year of sunlight exposure, the fluctuation range of the reflectance of the hexavalent passivated substrate increases to about 5%. When comparing the reflectance of the freshly hexavalent passivated substrate with the reflectance value after one year of sunlight exposure, the difference is in the range of about 8%.

Almost no degradation of the reflectance of an inventive passivation layer on a test steel-substrate was found after one year of sunlight exposure, while a passivation layer formed from passivation composition comprising hexavalent chromium according to the state of the art has shown a significant degradation of the reflectance after being exposure to sunlight for one year. Accordingly, the inventive passivation layer on a zinc layer or zinc-alloy layer has a significantly increased durability with respect of its appearance.

In an embodiment of the invention, the layer thickness of the inventive passivation layer can be in the range of between 0.025 μm and 2 μm, preferably between 0.2 μm and 1 μm.

In a further embodiment of the invention, the passivated substrate surface, i.e. the passivation layer formed on the zinc-layer or zinc-alloy layer, is sealed with an organic- or inorganic-based sealant. In a preferred embodiment the sealant further contains silicon oxide nano particles and/or PTFE nano particles. The sealant may be applied to result in a sealant layer thickness of 0.5 μm to 2 μm. The final coating of the passivated surface with a sealant can provide an additional increment to the corrosion protection.

The invention is further illustrated by the following additional examples:

### Example 3

A standard steel substrate is cleaned with a soak cleaner for about 5 to 10 minutes at a temperature of 50° C. to 70° C. After a rinse step, the substrate is electrolytically cleaned for about 5 to 10 minutes at a temperature of 50° C. to 70° C. After a further rinse step, the substrate is pre-treated in an acid dip of diluted hydrochloric acid for about 1 minute and additionally rinsed. The cleaned and pre-treated substrate is acid zinc plated in an electrolyte according to example 1 additionally comprising 30 ml/l of ENTHOBRITE CLZ CARRIER and 0.5 ml/l of ENTHOBRITE CLZ 970 B as brightener, both commercially available from Enthone Inc., West Haven, Conn. After rinsing of the surface, the deposited zinc layer is passivated by treating the substrate with a diluted acid dip (diluted nitric acid) for 10 to 30 seconds at room temperature and subsequent treatment with an inventive aqueous process solution comprising 25.0 g/l of chromium(III)sulphate monohydrate, 9.0 g/l sodium nitrate, 2.0 g/l formic acid (85 Vol.-%), as well as 1.0 g/l ammonium dithiodiglycolate for 2 minutes at about 20° C. After drying, the resulting substrate had a dark black appearance and an optical reflectance of 6%±1% within a wavelength range of 360 nm to 710 nm.

### Example 4

A standard steel substrate was cleaned and zinc-plated as described in example 3. The zinc-electrolyte used additionally comprised 1 ml/l of a thiodiglycol ethoxylate. After rinsing of the surface, the deposited zinc layer is passivated by treating the substrate with a diluted acid dip (diluted nitric acid) for 10 to 30 seconds at room temperature and subsequent treatment with an inventive aqueous process solution comprising 25.0 g/l of chromium(III)sulphate monohydrate, 9.0 g/l sodium nitrate, 2.0 g/l formic acid (85 Vol.-%), as well as 1.0 g/l ammonium dithiodiglycolate for 2 minutes at about 20° C. After drying, the resulting substrate had a dark black appearance and an optical reflectance of 6%±1% within a wavelength range of 360 nm to 710 nm.

### Example 5

A standard steel substrate was cleaned and zinc-plated as described in example 3. After rinsing of the surface, the deposited zinc layer is passivated by treating the substrate with a diluted acid dip (diluted nitric acid) for 10 to 30 seconds at room temperature and subsequent treatment with an inventive aqueous process solution comprising 28.0 g/l of chromium(III)chloride, 6.0 g/l ammonium nitrate, 2.5 g/l lactic acid, 0.75 g/l ammonium dithiodiglycolate, 0.15 g/l sodium fluoride, as well as 0.95 g/l cobalt(II)sulphate*7 aq. for 1.5 minutes at about 20° C. After drying, the resulting substrate had a dark black appearance and an optical reflectance of 5%±1% within a wavelength range of 360 nm to 710 nm.

### Example 6

A standard steel substrate is cleaned with a soak cleaner for about 5 to 10 minutes at a temperature of 50° C. to 70° C. After a rinse step, the substrate is electrolytically cleaned for about 5 to 10 minutes at a temperature of 50° C. to 70° C. After a further rinse step, the substrate is pre-treated in an acid dip of diluted hydrochloric acid for about 1 minute and additionally rinsed. The cleaned and pre-treated substrate is acid zinc plated in an electrolyte according to example 2 additionally comprising 25 ml/l of ENTHOBRITE CLZ CARRIER and 0.5 ml/l of ENTHOBRITE CLZ 970 B as brightener, both commercially available from Enthone Inc., West Haven, Conn. After rinsing of the surface, the deposited zinc layer is passivated by treating the substrate with a diluted acid dip (diluted nitric acid) for 10 to 30 seconds at room temperature and subsequent treatment with an inventive aqueous process solution comprising 25.0 g/l of chromium(III)sulphate monohydrate, 9.0 g/l sodium nitrate, 2.0 g/l formic acid (85 Vol.-%), as well as 1.25 g/l ammonium dithiodiglycolate for 2 minutes at about 20° C. After drying, the resulting substrate had a dark black appearance and an optical reflectance of 6%±1% within a wavelength range of 360 nm to 710 nm.

### Example 7

A standard steel substrate was cleaned and zinc-plated as described in example 6. The zinc-electrolyte used additionally comprised 1 ml/l of a thiodiglycol ethoxylate. After rinsing of the surface, the deposited zinc layer is passivated by treating the substrate with a diluted acid dip (diluted nitric acid) for 10 to 30 seconds at room temperature and subsequent treatment with an inventive aqueous process solution comprising 25.0 g/l of chromium(III)sulphate monohydrate, 9.0 g/l sodium nitrate, 2.0 g/l formic acid (85 Vol.-%), as well as 1.0 g/l ammonium dithiodiglycolate for 2 minutes at about 20° C. After drying, the resulting substrate had a dark black appearance and an optical reflectance of 6%±1% within a wavelength range of 360 nm to 710 nm.

### Example 8

A standard steel substrate was cleaned and zinc-plated as described in example 7. After rinsing of the surface, the deposited zinc layer is passivated by treating the substrate with a diluted acid dip (diluted nitric acid) for 10 to 30 seconds at room temperature and subsequent treatment with an inventive aqueous process solution comprising 28.0 g/l of chromium(III)chloride, 6.0 g/l ammonium nitrate, 1.4 g/l lactic acid, 1.0 g/l ammonium dithiodiglycolate, 0.15 g/l sodium fluoride, as well as 0.95 g/l cobalt(II)sulphate*7 aq. for 1.5 minutes at about 20° C. After drying, the resulting substrate had a dark black appearance and an optical reflectance of 5%±1% within a wavelength range of 360 nm to 710 nm.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1-8. (canceled)

9. A method for the formation of a passivation layer on a zinc layer or zinc-alloy layer, the method comprising the steps:
depositing a zinc or zinc-alloy layer on a substrate surface;
treating the deposited zinc or zinc-alloy layer with an aqueous process solution according to claim 18.

10. The method according to claim 9 wherein the zinc or zinc-alloy layer is deposited from an acidic electrolyte.

11. The method according to claim 9 or 10, wherein the zinc or zinc-alloy layer is deposited from an electrolyte comprising a thiodiglycol ethoxylate.

12. The method according to claim 11, wherein the zinc or zinc-alloy layer is deposited at a temperature ≦30° C.

13. The method according to claim 9 or 10, wherein subsequent to the formation of the passivation layer, the surface is treated with a film building polymeric solution to improve the corrosion resistance.

14. Use of a compound according to the general formula 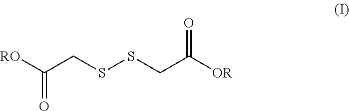
wherein R is H, Li, Na, K, NH₄, or a branched or unbranched alkyl group having 1 to 8 carbon atoms as additive in a composition for the deposition or passivation of metals on the surface of a substrate.

15. Passivation layer on a zinc layer or zinc-alloy layer, characterized in that the passivation layer has an average optical surface reflectance at a wavelength within the range of 360 nm to 710 nm of less than 8%, preferably less than 7%, wherein the fluctuation range of the reflectance is ≦2%, preferably ≦1%.

16. The method of claim 9 for forming a passivation layer on a zinc layer or zinc-alloy layer, the method comprising the steps:
the depositing the zinc or zinc alloy layer on a substrate surface; and
the treating the deposited zinc or zinc-alloy layer with an aqueous process solution according to claim 1 or 2;
wherein the depositing the zinc or zinc alloy layer comprises deposition at a temperature ≦30° C. from an acidic electrolyte comprising between 0.01 mol/l to 0.1 mol/l of a thiodiglycol ethoxylate; and
wherein the treating comprises treatment with a solution comprising between 4 mmol to 0.2 mol/l of the trivalent chromium ions, between 0.1 mmol/l and 1 mol/l of the dithioglycolate, between 0 and 2 mol/l of the nitrate ions; and
wherein the organic acid is at least one acid of the group consisting of citric acid, malonic acid, formic acid, tartaric acid, lactic acid, malic acid, gluconic acid, ascorbic acid, oxalic acid, succinic acid, and adipic acid.

17. The method of claim 16 wherein the dithioglycolate in the treatment solution is ammonium dithioglycolate.

18. An aqueous process solution useful for forming a passivation layer on a zinc or zinc alloy layer comprising a combination of:
a source of trivalent chromium ions;
a source of nitrate ions selected from the group consisting of ammonium nitrate and alkali metal nitrates;
a dithiodiglycolate salt;
a carboxylic acid; and
water.

19. An aqueous process solution as set forth in claim 18 wherein said dithiodiglycolate salt comprises ammonium dithiodiglycolate.

20. An aqueous process solution as set forth in claim 18 or 19 wherein said carboxylic acid comprises a monocarboxylic acid selected from the group consisting of formic acid, acetic acid, propionic acid, and lactic acid.

21. An aqueous process solution as set forth in any of claims 18 to 20 wherein said carboxylic acid comprises a polycarboxylic acid selected from the group consisting of succinic acid, oxalic acid, citric acid and malonic acid.

22. An aqueous process solution as set forth in any of claims 18 to 23 wherein said carboxylic acid comprises an α-hydroxy acid.

23. An aqueous process solution as set forth in any of claims 18 to 23 further comprising fluoride or bifluoride ions.

24. An aqueous process solution as forth in any of claims 18 to 23 wherein said source of trivalent chromium ions is selected from the group consisting of chromium sulfate and chromium chloride.

25. An aqueous process solution set forth in claim 24 wherein said source of trivalent chromium ions comprises chromium sulfate.

26. An aqueous process solution as set forth in any of claims 18 to 25 that is substantially free of phosphite ions.

27. An aqueous process solution as set forth in any of claims 18 to 26 that is substantially free of zinc ions.

28. An aqueous process solution as set forth in any of claims 18 to 27 further comprising ions of a metal selected from the group consisting of Sc, Y, Ti, Zr, Mo, W, Mn, Fe, Co, Ni, B, Al and Si.

29. An aqueous solution as set forth in any of claims 18 to 28 further comprising ethylene diamine tetraacetic acid, nitrilo triacetic acid, and ethylene diamine disuccinic acid.
